(19) United States
(12) Patent Application Publication
(10) Pub. No.: US 2026/0313536 A1
(43) Pub. Date: Oct. 8, 2026

(54) METHOD AND APPARATUS FOR CONFIGURED GRANT (CG) AND SEMI-PERSISTENT SCHEDULING (SPS) OPERATION CONSIDERING DTX/DRX OPERATION OF BASE STATION IN NEXT-GENERATION MOBILE COMMUNICATION SYSTEM

(71) Applicant: Samsung Electronics Co., Ltd., Gyeonggi-do (KR)

(72) Inventors: Weiping SUN, Gyeonggi-do (KR); Sangkyu BAEK, Gyeonggi-do (KR); Jaehyuk JANG, Gyeonggi-do (KR)

(21) Appl. No.: 19/482,636

(22) PCT Filed: May 13, 2024
(86) PCT No.: PCT/KR2024/006450

§ 371 Date: Nov. 7, 2025

(30) Foreign Application Priority Data
May 11, 2023 (KR) 10-2023-0061088

(51) Int. Cl. H04W 52/02; H04W 72/11; H04W 72/231; H04W 76/28

(52) U.S. Cl. CPC H04W 52/0206; H04W 72/11; H04W 72/231; H04W 76/28

(57) ABSTRACT

A distributed control method and apparatus for energy saving in a small cell network are provided. A base station analyzes the number of connected mobile terminals and a traffic load state, if the number of connected terminals and the traffic load satisfy a preset condition, the base station collects neighboring cell base station state information from a neighboring cell base station, and based on neighboring cell base station state information and signal strengths of the neighboring cell base stations of the accessed mobile terminals, the base station determines, for each mobile terminal, whether a handover to a neighboring cell base station is possible and if the handover is not possible for some mobile terminals, the base station increases a handover probability by appropriately expanding a coverage of the neighboring cell base station. When all accessed mobile terminals can be handed over to the neighboring cell base station, the base station minimizes transmission output, and the mobile terminals within the coverage of the base station perform the handover to the neighboring cell base station to continue receiving a service.

### TECHNICAL FIELD

The disclosure relates to a method for reducing power consumption of a base station and a method for data transmission and reception between a terminal and a base station.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

An aspect of the disclosure is to provide a processing method and device for a case where a non-active period (NAP) of cell discontinuous transmission/discontinuous reception (DTX/DRX) collides with a resource configured by semi-persistent scheduling (SPS) or configured grant (CG) when a cell DTX/DRX method for reducing the power consumption of a base station is applied.

The technical subjects pursued in the disclosure may not be limited to the above-mentioned technical subjects, and other technical subjects which are not mentioned herein may be clearly understood from the following description by those skilled in the art to which the disclosure pertains.

### Technical Solution

In order to achieve the above task, a method performed by a terminal in a wireless communication system according to an embodiment of the disclosure may include receiving, from a base station, at least one of semi persistent scheduling (SPS) configuration information related to repetition transmission of data according to SPS, or configured grant (CG) configuration information related to repetition transmission of data according to a CG, receiving at least one of cell discontinuous transmission (DTX) configuration information or cell discontinuous reception (DRX) configuration information from the base station, and receiving, from the base station, a subset of SPS data not overlapping a non-active period (NAP) of cell DTX among SPS data to be repetitively transmitted, based on the SPS configuration information and the cell DTX configuration information, or transmitting, to the base station, a subset of uplink data not overlapping an NAP of cell DRX among uplink data to be repetitively transmitted according to the CG, based on the CG configuration information and the cell DRX configuration information.

According to an embodiment, the SPS configuration information or the CG configuration information included in a radio resource control (RRC) message may be received.

According to an embodiment, a subset of SPS data overlapping the NAP of the cell DTX among the SPS data to be repetitively transmitted may not be monitored, and a subset of uplink data overlapping the NAP of the cell DRX among the uplink data to be repetitively transmitted according to the CG may not be transmitted to the base station.

According to an embodiment, a redundancy version (RV) value of each of the SPS data included in the subset of SPS data may be determined based on an ordinal number of corresponding SPS data among valid SPS data.

According to an embodiment, an RV value of each of the uplink data included in the subset of uplink data may be determined based on which an ordinal number of corresponding uplink data among valid uplink data.

In addition, in order to achieve the above task, a method performed by a base station in a wireless communication system according to an embodiment of the disclosure may include transmitting, to a terminal, at least one of semi persistent scheduling (SPS) configuration information related to repetition transmission of data according to SPS, or configured grant (CG) configuration information related to repetition transmission of data according to a CG, transmitting at least one of cell discontinuous transmission (DTX) configuration information or cell discontinuous reception (DRX) configuration information to the terminal, and transmitting, to the terminal, a subset of SPS data not overlapping a non-active period (NAP) of cell DTX among SPS data to be repetitively transmitted, based on the SPS configuration information and the cell DTX configuration information, or receiving, from the terminal, a subset of uplink data not overlapping an NAP of cell DRX among uplink data to be repetitively transmitted according to the CG, based on the CG configuration information and the cell DRX configuration information.

According to an embodiment, a subset of SPS data overlapping the NAP of the cell DTX among the SPS data to be repetitively transmitted may not be transmitted to the terminal, and a subset of uplink data overlapping the NAP of the cell DRX among the uplink data to be repetitively transmitted according to the CG may not be received from the terminal.

In addition, in order to achieve the above task, a terminal in a wireless communication system according to an embodiment of the disclosure may include a transceiver and a controller, wherein the controller is configured to receive, from a base station through the transceiver, at least one of semi persistent scheduling (SPS) configuration information related to repetition transmission of data according to SPS, or configured grant (CG) configuration information related to repetition transmission of data according to a CG, receive at least one of cell discontinuous transmission (DTX) configuration information or cell discontinuous reception (DRX) configuration information from the base station through the transceiver, and receive, from the base station through the transceiver, a subset of SPS data not overlapping a non-active period (NAP) of cell DTX among SPS data to be repetitively transmitted, based on the SPS configuration information and the cell DTX configuration information, or transmit, to the base station and through the transceiver, a subset of uplink data not overlapping an NAP of cell DRX among uplink data to be repetitively transmitted according to the CG, based on the CG configuration information and the cell DRX configuration information.

In addition, in order to achieve the above task, a base station in a wireless communication system according to an embodiment of the disclosure may include a transceiver and a controller, wherein the controller is configured to transmit, to a terminal through the transceiver, at least one of semi persistent scheduling (SPS) configuration information related to repetition transmission of data according to SPS, or configured grant (CG) configuration information related to repetition transmission of data according to a CG, transmit at least one of cell discontinuous transmission (DTX) configuration information or cell discontinuous reception (DRX) configuration information to the terminal through the transceiver, and transmit, to the terminal through the transceiver, a subset of SPS data not overlapping a non-active period (NAP) of cell DTX among SPS data to be repetitively transmitted, based on the SPS configuration information and the cell DTX configuration information, or receive, from the terminal and through the transceiver, a subset of uplink data not overlapping an NAP of cell DRX among uplink data to be repetitively transmitted according to the CG, based on the CG configuration information and the cell DRX configuration information.

### Advantageous Effects

The disclosure may provide a processing method and device for a case where an NAP of cell DTX/DRX collides with a resource configured by SPS or CG when a cell DTX/DRX method for reducing the power consumption of a base station is applied.

Advantageous effects obtainable from the disclosure may not be limited to the above-mentioned effects, and other effects which are not mentioned herein may be clearly understood from the following description by those skilled in the art to which the disclosure pertains.

### DESCRIPTION OF DRAWINGS

FIG. 1 illustrates a structure of an NR system according to an embodiment of the disclosure.

FIG. 2 illustrates a radio protocol structure in an NR system according to an embodiment of the disclosure.

FIG. 3 is a diagram illustrating a cell DTX/DRX operation according to an embodiment of the disclosure.

FIG. 4 is a diagram illustrating an SPS configuration and a transmission and reception operation between a base station and a terminal according to an embodiment of the disclosure.

FIG. 5 is a diagram illustrating a CG configuration and a related transmission and reception operation between a base station and a terminal according to an embodiment of the disclosure.

FIG. 6 is a diagram illustrating a criterion for determining whether a PUSCH TO allocated by a CG or a PDSCH TO allocated by SPS is valid according to an embodiment of the disclosure.

FIG. 7 is a diagram illustrating a criterion for determining whether a PUSCH TO allocated by a CG or a PDSCH TO allocated by SPS is valid when bundling is used according to an embodiment of the disclosure.

FIG. 8 is a diagram illustrating a criterion for determining whether a particular PDSCH or PDSCH bundle allocated by SPS is valid/invalid according to an embodiment of the disclosure.

FIG. 9 illustrates a structure of a UE according to an embodiment of the disclosure.

FIG. 10 illustrates a structure of a network entity according to an embodiment of the disclosure.

### MODE FOR INVENTION

Hereinafter, exemplary embodiments of the disclosure will be described in detail with reference to the accompanying drawings. It should be noted that, in the accompanying drawings, the same or like elements are designated by the same or like reference signs, if possible. Also, a detailed description of known functions or configurations that may make the subject matter of the disclosure unnecessarily unclear will be omitted.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing a communication function. Furthermore, the embodiments of the disclosure as described below may also be applied to other communication systems having similar technical backgrounds or channel types to the embodiments of the disclosure. Moreover, based on determinations by those skilled in the art, the embodiments of the disclosure may also be applied to other communication systems through some modifications without significantly departing from the scope of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, terms for identifying access nodes, terms referring to network entities or network functions (NFs), terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform other standards.

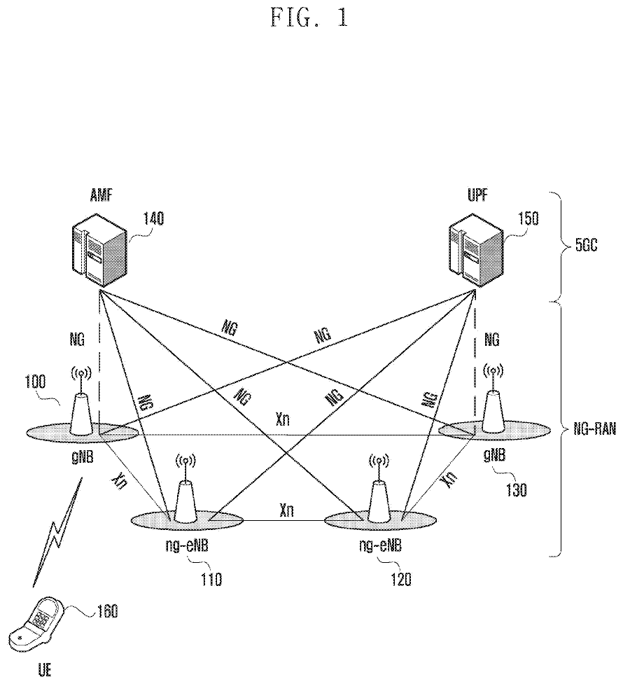

FIG. 1 illustrates a structure of an NR system according to an embodiment of the disclosure.

Referring to FIG. 1, a wireless communication system may include multiple base stations (for example, a gNB 100, an ng-eNB 110, an ng-eNB 120, and a gNB 130), an access and mobility management function (AMF) 140, and a user plane function (UPF) 150. Of course, the wireless communication system is not limited by the structure illustrated in FIG. 1, and may include a larger or smaller number of components than those in the structure illustrated in FIG. 1.

According to an embodiment of the disclosure, a user equipment (hereinafter UE or terminal) 160 may access an external network via the base stations 100, 110, 120, and 130 and the UPF 150.

In FIG. 1, the base stations 100, 110, 120, and 130 may provide radio access to UEs that access the network as cellular network access nodes. For example, in order to service users' traffic, the base stations 100, 110, 120, and 130 may collect state information of UEs 160, such as the UEs' buffer states, available transmission power states, and channel states, and perform scheduling accordingly, thereby supporting connections between the UEs and the core network (CN; in particular, CN in NR is referred to as “5GC”).

In FIG. 1, the gNBs 100 and 130 may control multiple cells and employ an adaptive modulation & coding (hereinafter referred to as AMC) scheme for determining a modulation scheme and a channel coding rate according to a channel state of the UE 160.

The core network (CN) 140 and 150 is a device responsible for various control functions as well as a mobility management function for UEs % n, and may be connected to multiple base stations 100, 110, 120, and 130. Also, the 5GC may interwork with the existing LTE system.

A wireless communication system may include a user plane (UP) associated with actual user data transmission and a control plane (CP) such as connection management. In FIG. 1, the gNB 100 and gNB 130 may use UP and CP technology defined in the NR technology, and although connected to the 5GC, the ng-eNB 110 and ng-eNB 120 may use UP and CP technology defined in the long term evolution (LTE) technology.

The AMF 140 is a device responsible for various control functions as well as a mobility management function for a UE, and may be connected to multiple base stations 100, 110, 120k, and 130.

The UPF 150 may refer to a type of gateway device for providing data transmission. Although not illustrate in FIG. 1, the NR wireless communication system may include a session management function (SMF). The SMF may manage a packet data network connection such as a protocol data unit (PDU) session provided to the UE 160.

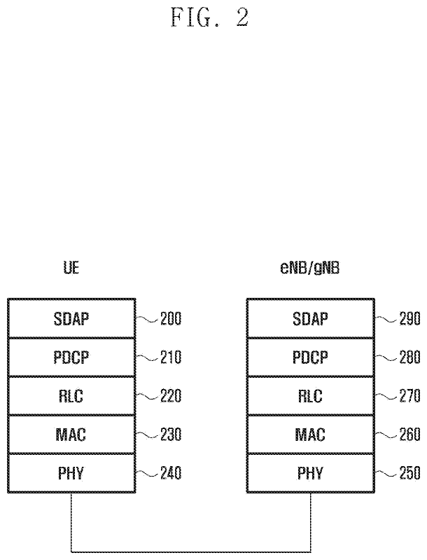

FIG. 2 illustrates a radio protocol structure in an NR system according to an embodiment of the disclosure.

Referring to FIG. 2, a radio protocol of an NR system may include a service data adaptation protocol (SDAP) 200 or 290, a packet data convergence protocol (PDCP) 210 or 280, a radio link control (RLC) 220 or 270, a medium access control (MAC) 230 or 260, and physical (PHY) 240 or 250 on each of UE and base station sides.

The SDAP 200 or 290 may perform an operation for transferring user plane data, an operation for mapping between a QoS flow and a specific DRB for both uplink and downlink, and an operation for mapping a reflective QoS flow to a data bearer for uplink SDAP PDUs. An SDAP configuration corresponding to each DRB may be provided from a higher RRC layer. Of course, the functions of the SDAP 200 or 290 are not limited to the above examples.

The packet data convergence protocol (PDCP) 210 or 280 may be responsible for operations such as IP header compression/reconstruction. Also, the PDCP 210 or 280 may provide an in-sequence delivery function, an out-of-sequence delivery function, a reordering function, a retransmission function, and a ciphering and deciphering function. Of course, the functions of the PDCP 210 or 280 are not limited to the above examples.

The RLC 220 or 270 may reconfigure a PDCP protocol data unit (PDU) into appropriate sizes. Also, the RLC 220 or 270 may provide an in-sequence delivery function, an out-of-sequence delivery function, an automatic repeat request (ARQ) function, a concatenation, segmentation, and reassembly function, a re-segmentation function, a reordering function, a duplicate detection function, and an error detection function. Of course, the functions of the RLC 220 or 270 are not limited to the above examples.

The MAC 230 or 260 may be connected to several RLC layer devices configured in a single UE, and perform operations of multiplexing RLC PDUs into an MAC PDU and demultiplexing RLC PDUs from an MAC PDU. Also, the MAC 230 or 260 may provide a mapping function, a scheduling information reporting function, an HARQ function, a priority handling function between logical channels, a priority handling function between UEs, an MBMS service identification function, a transport format selection function, and a padding function. Of course, the functions of the MAC 230 or 260 are not limited to the above examples.

The physical (PHY) layer 240 or 250 may perform operations of channel-coding and modulating higher layer data, thereby obtaining OFDM symbols, and delivering the same through a radio channel, or demodulating OFDM symbols received through the radio channel, channel-decoding the same, and delivering the same to the higher layer. For additional error correction, the PHY layer may also use hybrid ARQ (HARQ), and a receiving end may use one bit to transmit whether a packet transmitted by a transmitting end is received. This 1-bit information is referred to as HARQ AQCK/NACK information.

In the case of LTE, downlink HARQ ACK/NACK information in response to uplink data transmission may be transmitted via a physical ARQ indicator channel (PHICH), and in the case of NR, whether retransmission is required or new transmission has only to be performed may be determined through UE scheduling information via a physical dedicated control channel (PDCCH) that is a channel via which downlink/uplink resource allocation and the like are transmitted. This is because asynchronous HARQ is applied in NR. Uplink HARQ ACK/NACK information in response to downlink data transmission may be transmitted through a physical uplink control channel (PUCCH) or through a physical uplink shared channel (PUSCH). The PUCCH is generally transmitted in an uplink of a PCell as described below, but if supported by a UE, a base station may also additionally transmit the same to the corresponding UE in an SCell as described below, which is referred to as a PUCCH SCell.

Although not illustrated in FIG. 2, a radio resource control (RRC) layer may exist as a higher layer than each PDCP layer of the UE and the base station, and the RRC layer may exchange access/measurement-related configuration control messages for radio resource control.

The PHY layer may include one or multiple frequencies/carriers, and a technology for simultaneously configuring and using multiple frequencies is referred to as carrier aggregation (hereinafter CA). The CA refers to a technology in which, instead of using only one carrier for communication between a UE and a base station (eNB or gNB), one primary carrier and multiple secondary carriers are additionally used and thus data capacity may be greatly increased as much as the number of secondary carriers. In LTE/NR, a cell in a base station, which uses the primary carrier, is referred to as a primary cell or PCell, and a cell in a base station, which uses the secondary subcarriers, is referred to as a secondary cell or SCell.

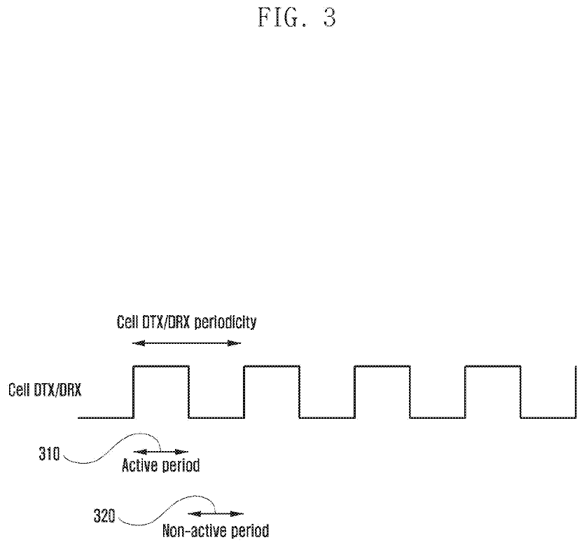

FIG. 3 is a diagram illustrating cell DTX/DRX for reducing the power consumption of a base station according to an embodiment of the disclosure.

In a mobile communication system, a base station consumes considerable power because the base station needs to provide service to multiple UEs within a service area. Therefore, network energy saving (NES) technologies for reducing the power consumption of the base station are being discussed. For example, candidate technologies as follows are being proposed in the NR standard.
Cell discontinuous transmission/discontinuous reception (DTX/DRX)
NES-aware conditional handover (CHO)
Synchronization signal/physical broadcast channel (SS/PBCH block, SSB)-less/system information block (SIB)-less cell
Cell (re) selection enhancement
UE wake-up signal (WUS)
UE assistance information for NES

Among the technologies, cell DTX/DRX is a technology for periodically turning on or off data transmission or reception of a base station. Cell DTX is a technology for turning on or off data transmission of the base station in downlink, and cell DRX is a technology for turning on or off data reception of the base station in uplink. During a time interval in which the base station turns off data transmission or reception, the power consumption of the base station may be significantly reduced.

Referring to FIG. 3, when cell DTX or cell DRX is executed, a base station may perform, in every predetermined cell DTX or cell DRX periodicity 300 configured by an active period (AP) 310 and a non-active period (NAP) 320, a predetermined operation corresponding to the period. During the cell DTX AP period 310, the base station may perform normal transmission operations, and during the cell DTX NAP period 320, may not perform normal transmission operations. During the cell DRX AP period 310, the base station may perform normal reception operations, and during the cell DRX NAP period 320, may not perform normal reception operations. For example, during the cell DRX NAP 320, the base station may not allow a particular UE to use a downlink (DL) resource periodically scheduled to the UE through semi-persistence scheduling (SPS). For example, during the cell DRX NAP 320, the base station may not allow a particular UE to use an uplink (UL) resource periodically scheduled to the UE through a configured grant (CG, including both CG Type 1 and Type 2).

Therefore, the base station may not perform data transmission/reception during the NAP 320 of cell DTX/DRX. As an embodiment of the disclosure, the base station may transfer DTX/DRX-related configuration information of a particular cell to a UE through an RRC message. The UE may receive the DTX/DRX-related configuration information of the particular cell in the RRC layer, and then transfer the configuration information to a lower layer (a layer such as PDCP, RLC, MAC, or PHY) through internal signaling. As an embodiment of the disclosure, the UE may receive the DTX/DRX configuration information of the particular cell and then configure a DTX/DRX-related timer of the cell, based on the configuration information. As an embodiment of the disclosure, the cell DTX/DRX-related time managed by the UE may be a timer indicating the remaining time of an AP or an NAP.

As an embodiment of the disclosure, the UE may determine the AP 310 or the NAP 320, based on a state of the DTX/DRX AP or NAP timer of the cell. For example, in a case of a cell DTX/DRX AP timer, the timer may start at a start time point of the cell DTX/DRX AP 310 and expires at an expiry time point of the cell DTX/DRX AP 310. In addition, the magnitude of the cell DTX/DRX AP 310 or the magnitude of the cell DTX/DRX AP timer may be configured for the UE through RRC signaling. For example, the expiry time point of the cell DTX/DRX AP timer may be the start time point of the cell DTX/DRX NAP 320. For example, one cell DTX/DRX NAP 320 and one cell DTX/DRX AP 310 may configure one cell DTX/DRX periodicity 300. As another example, in a case of a cell DTX/DRX NAP timer, the timer may start at a start time point of the cell DTX/DRX NAP 320 and expires at an expiry time point of the cell DTX/DRX NAP 320. For example, the magnitude of the cell DTX/DRX NAP 320 or the magnitude of the NAP timer may be directly configured by an NW for the UE through RRC signaling, or may be configured to be a value remaining after subtracting the magnitude (or on-duration) of the AP configured through RRC signaling from the cell DTX/DRX periodicity 300 configured by the NW through RRC signaling.

The disclosure proposes a method of, when a DL or UL resource allocated by a base station to a particular UE through SPS or CG partially overlaps the cell DTX/DRX NAP 320, determining whether the resource is used, and a related UE operation.

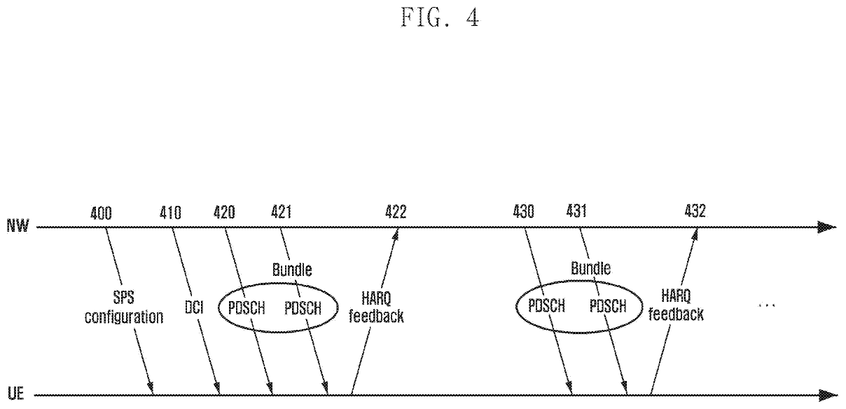

FIG. 4 is a diagram illustrating an SPS configuration and a transmission and reception operation between a base station and a UE according to an embodiment of the disclosure.

In order for a base station to transmit a physical downlink shared channel (PDSCH) of a particular transport block (TB) to a UE, the base station needs to allocate a time/frequency resource used for transmitting the PDSCH to the UE and notify the UE of the resource in advance. The UE may monitor the allocated and notified time/frequency resource and, at this time, process the PDSCH received through the resource to determine whether the TB has been successfully received. Typically, whenever the base station transmits a PDSCH to the UE, the base station may transmit downlink control information (DCI) through a PDCCH in advance to allocate and notify of a time/frequency resource of a corresponding PDSCH. However, if, due to traffic characteristics, the base station transmits a PDSCH to the UE by periodically allocating a time/frequency resource of the same size, the base station may, instead of transmitting DCI to the UE each time, allocate a PDSCH resource once with the DCI and thereafter, configure the UE to continuously and periodically use a time/frequency resource of the same size. The base station may configure the above operation through SPS. Through the SPS configuration, the base station may configure a periodicity of the periodically allocated PDSCH resource. In addition, the base station may transmit DCI satisfying a particular condition to allocate/notify of a time/frequency resource of a first PDSCH and, starting with the first PDSCH, periodically allocate a time/frequency resource of the same size according to the SPS periodicity.

Referring to FIG. 4, a base station (NW) may transmit, to a UE, an SPS-related configuration 400 through a particular information element (IE) (e.g., SPS-Config) of an RRC message.

The base station may transmit DCI satisfying a particular condition defined in a specification to the UE (410), and perform corresponding SPS activation. A periodic PDSCH resource allocated by SPS may be used only when SPS activation is performed.

The base station may periodically allocate a PDSCH resource to the UE through SPS. For example, the base station may allocate, to the UE and through one-time allocation of a PDSCH resource, the same resources for multiple adjacent slots starting from a slot where the PDSCH resource is positioned, to configure the UE to receive multiple PDSCHs in the multiple adjacent slots (PDSCH bundle). The base station may configure a value greater than 1 as pdsch-AggregationFactor in an SPS configuration (e.g., configuration for a particular SPS through SPS-Config) or a PDSCH configuration (e.g., configuration for all SPSs through PDSCH-Config) through an RRC message to configure the above operation for the UE. If a corresponding field is configured in both SPS-Config and PDSCH-Config, pdsch-AggregationFactor of a particular SPS may be configured based on a value configured in SPS-Config of the SPS. An SPS having pdsch-AggregationFactor configured to be a value greater than 1 may have multiple PDSCH transmission occasions (TOs) in a number of consecutive slots corresponding to a count configured by the pdsch-AggregationFactor starting from a corresponding PDSCH resource with respect to each PDSCH resource allocated periodically. In this case, multiple PDSCH TOs 420 and 421 or 430 and 431 may be called a PDSCH bundle. The multiple PDSCH TOs 420 and 421 or 430 and 431 belonging to a PDSCH bundle may be used to transmit and receive PDSCHs having particular redundancy version (RV) values generated from the same TB (420 and 421 or 430 and 431). An n-th (n starts from 0) PDSCH TO belonging to a particular PDSCH bundle may apply a corresponding RV value according to a rule previously defined based on n mod 4. For example, the RV value may be previously determined as shown in [Table 1] below.

TABLE 1

| n mod 4 = 0 | n mod 4 = 1 | n mod 4 = 2 | n mod 4 = 3 |
|---|---|---|---|
| 0 | 2 | 3 | 1 |

The UE for which a PDSCH bundle is configured may receive multiple PDSCHs transmitted by the base station in multiple PDSCH TOs of a particular PDSCH bundle and then determine whether a corresponding transport block (TB) has been successfully received, by using all the received PDSCHs. The UE for which a PDSCH bundle is not configured may receive one PDSCH and then determine whether a corresponding TB has been successfully received. Whether the UE has successfully received the TB may be transferred to the base station through a HARQ feedback (ACK or NACK) (422 and 432). The HARQ feedback may be included in uplink control information (UCI) and transferred to the base station. A resource position of the HARQ feedback on the time axis may be determined considering an offset value determined through DCI having been used for SPS activation together, based on the position of a corresponding PDSCH TO on the time axis.

The difference (e.g., the difference between the PDSCH 430 and the PDSCH 420) between two consecutive PDSCH resource allocation times allocated by SPS may be determined to be a periodicity value configured in SPS-Config.

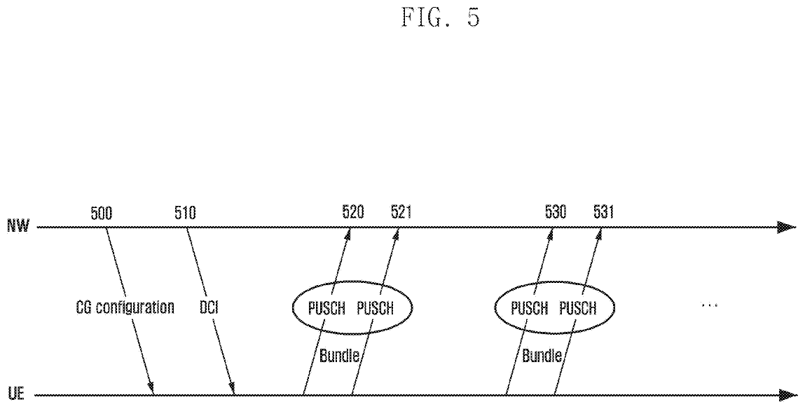

FIG. 5 is a diagram illustrating a CG configuration and a related transmission and reception operation between a base station and a UE according to an embodiment of the disclosure.

In order to transmit a PUSCH of a particular TB, a UE needs to be allocated and notified in advance by a base station of a time/frequency resource used for transmitting the PUSCH. The UE may transmit the PUSCH by using the allocated and notified time/frequency resource. Typically, when UL data occurs, the UE informs the base station of the size of the UL data through a buffer status report (BSR), and the base station may allocate a corresponding UL grant to the UE and notify the UE of the UL grant through DCI. If, due to UL traffic characteristics, the base station transmits a PUSCH to the UE by periodically allocating a time/frequency resource of the same size, it may be more efficient for the base station to allocate a PUSCH resource to the UE once through DCI and then configure the UE to continue using a time/frequency resource of the same size periodically, rather than allocating a resource through a BSR and DCI each time. The base station may configure the above operation through CG. The base station may configure CG for the UE through an RRC message. A CG configuration may include information for configuring a periodicity of a PUSCH resource. The base station may configure CG Type 1 through a CG configuration. In a case of CG Type 1, periodic PUSCH resource allocation may occur immediately when a CG is configured through an RRC message. When CG Type 1 is configured, the UE may transmit uplink data in a PUSCH resource allocated according to a CG Type 1 configuration without receiving separate DCI. In a case of CG Type 2, periodic PUSCH resource allocation may occur only when a CG is configured through an RRC message and the CG is activated through particular DCI. When CG Type 2 is configured, the UE may transmit uplink data in a PUSCH resource allocated by CG Type 2 after receiving a message for activation through DCI.

Through a CG configuration (e.g., ConfiguredGrantConfig), the base station may configure a periodicity of a periodically allocated PUSCH resource. In addition, the base station may transmit DCI satisfying a particular condition to allocate/notify of a time/frequency resource of a first PUSCH of CG Type 2 and, starting with the first PUSCH, periodically allocate a time/frequency resource of the same size according to the CG periodicity.

Referring to FIG. 5, a base station may transmit, to a UE, a CG-related configuration 500 through a particular IE (e.g., ConfiguredGrantConfig) of an RRC message.

According to an embodiment, the base station may transmit DCI satisfying a particular condition defined in a specification to the UE (510), and perform corresponding CG activation. In a case of CG Type 2, a periodic PUSCH resource allocated by the CG may be used only when CG activation is performed.

The base station may periodically allocate a PUSCH resource to the UE through a CG. For example, the base station may allocate, to the UE and through one-time allocation of a PUSCH resource, the same resources for multiple adjacent slots starting from a slot where the PUSCH resource is positioned, to configure the UE to transmit multiple PUSCHs in the multiple adjacent slots (PUSCH bundle). The base station may configure a value greater than 1 as a PUSCH bundle size (e.g., repK) in a CG configuration (e.g., configuration for a particular CG through ConfiguredGrantConfig) or a PUSCH configuration (e.g., configuration for all CGs through PUSCH-Config) through an RRC message to configure the above operation.

A CG for which a PUSCH bundle is configured may have multiple PUSCH transmission occasions (TOs) in a number of consecutive slots corresponding to a configured count starting from a corresponding PUSCH resource with respect to each PUSCH resource allocated periodically. In this case, multiple PUSCH TOs 520 and 521 or 530 and 531 may be called a PUSCH bundle. The multiple PUSCH TOs belonging to a PUSCH bundle may be used to transmit and receive PUSCHs having particular RV values generated from the same TB (520 and 521 or 530 and 531). If repK is configured to have a value greater than 1, when repK-RV is not configured, all the PUSCHs belonging to a PUSCH bundle may be configured to be RV 0. The base station may configure repK-RV through an RRC message. repK-RV may be one of (0,2,3,1), (0,3,0,3), and (0,0,0,0). If repK-RV is configured, an n-th (n starts from 1) PUSCH TO belonging to a particular PUSCH bundle may be configured to have an RV value of a k-th element of repK-RV. n and k may have a correlation based on a previously defined rule. For example, n and k may have a relation of k=(mod(n−1,4)+1).

As an embodiment of the disclosure, a TO may be a PUSCH TO or a PDSCH TO. For example, a bundle may refer to a PDSCH bundle or a PUSCH bundle. A NAP may be a cell DTX NAP or cell DRX NAP. A particular TO being valid may imply that, when the TO is a PDSCH TO, the UE needs to monitor a corresponding resource in the PDSCH TO, and when the TO is a PUSCH TO, the UE is able to transmit a PUSCH in the PUSCH TO. On the contrary, a particular TO being invalid may imply that, when the TO is a PDSCH TO, the UE is not required to monitor a corresponding resource in the PDSCH TO, and when the TO is a PUSCH TO, the UE is unable to transmit a PUSCH in the PUSCH TO.

As an embodiment of the disclosure, when a correlation between a TO and an NAP on the time axis is expressed in the disclosure, if the TO is a PDSCH TO, the NAP may be a cell DTX NAP, and if the TO is a PUSCH TO, the NAP may be a cell DRX NAP. As an embodiment of the disclosure, when a correlation between a TO and an AP on the time axis is expressed in the disclosure, if the TO is a PDSCH TO, the AP may be a cell DTX AP, and if the TO is a PUSCH TO, the AP may be a cell DRX AP.

As an embodiment of the disclosure, all thresholds mentioned in the disclosure may be previously defined in a specification or may be configured for the UE by the base station through an RRC message.

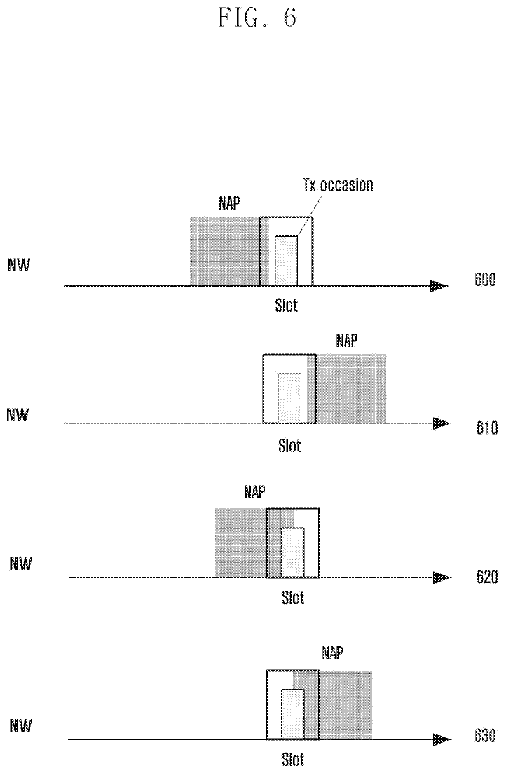

FIG. 6 is a diagram illustrating a criterion for determining whether a PUSCH TO allocated by a CG or a PDSCH TO allocated by SPS is valid according to an embodiment of the disclosure.

Referring to FIG. 6, in a case where a particular TO and an NAP do not overlap, but a slot to which the TO belongs partially overlaps the NAP (600 and 610), the UE may determine whether the TO is valid as one of the following options.
Option 1: The TO may be valid.
Option 2: The TO may be invalid.
Option 3: If the difference between the start time point of the TO and the expiry time point of an NAP which is closest to and is positioned immediately before the TO is greater than a particular threshold, and/or if the difference between the expiry time point of the TO and the start time point of an NAP which is closest to and is positioned immediately after the TO is greater than the particular threshold, the TO may be valid. On the contrary, when the above condition is not satisfied, the TO may be invalid.
Option 4: If the base station configures a particular function, whether the TO is valid may be determined as one of option 1 to option 3 above. If the function is not configured, whether the TO is valid may be determined as one of option 1 to option 3 above. The function may be configured in a unit of a UE, a unit of a cell, a unit of a bandwidth part (BWP), or a unit of a CG/SPS.

Referring to FIG. 6, in a case where a particular TO partially overlaps an NAP (620 and 630), the UE may determine whether the TO is valid as one of the following options.
Option 1: The TO may be valid.
Option 2: The TO may be invalid.
Option 3: If the first symbol of the TO does not overlap the NAP, the TO may be valid. On the contrary, if the first symbol of the TO overlaps the NAP, the TO may be invalid.
Option 4: If the last symbol of the TO does not overlap the NAP, the TO may be valid. On the contrary, if the last symbol of the TO overlaps the NAP, the TO may be invalid.
Option 5: If the base station configures a particular function, whether the TO is valid may be determined as one of option 1 to option 4 above. If the function is not configured, whether the TO is valid may be determined as one of option 1 to option 4 above. The function may be configured in a unit of a UE, a unit of a cell, a unit of a bandwidth part (BWP), or a unit of a CG/SPS.

For example, if the difference between the start time point of the particular TO and the expiry time point of an NAP which is closest to and is positioned immediately before the TO is greater than a particular threshold, and/or if the difference between the expiry time point of the TO and the start time point of an NAP which is closest to and is positioned immediately after the TO is greater than the particular threshold, the TO may be valid. On the contrary, when the above condition is not satisfied, the TO may be invalid.

For example, if all the symbols of a particular TO overlaps an NAP, the TO may be invalid. For example, if all the symbols of a particular TO overlaps an AP, the TO may be valid.

For example, if a particular TO is valid, the TO may be considered to belong to an AP. For example, if a particular TO is invalid, the TO may be considered to belong to an NAP.

For example, if all the symbols of a particular TO overlaps an NAP, the TO may be considered to belong to an NAP. For example, if all the symbols of a particular TO overlaps an AP, the TO may be considered to belong to an AP.

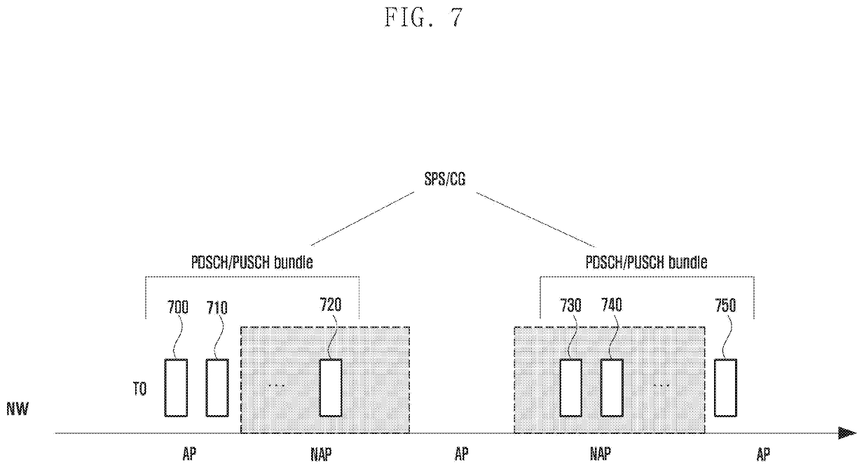

FIG. 7 is a diagram illustrating a criterion for determining whether a PUSCH TO allocated by a CG or a PDSCH TO allocated by SPS is valid when bundling is used according to an embodiment of the disclosure.

For example, if all the TOs belonging to a PDSCH bundle or a PUSCH bundle belongs to an AP, all the TOs belonging to the bundle may be valid. For example, if all the TOs belonging to a PDSCH bundle or a PUSCH bundle belongs to an NAP, all the TOs belonging to the bundle may be invalid.

Referring to FIG. 7, when at least one TO among TOs belonging to a PDSCH bundle or PUSCH bundle belongs to an AP and at least one TO belongs to an NAP, a method for determining whether each TO is valid/invalid may be one of the following methods.
Option 1: All TOs 700, 710, and 720, or 730, 740, and 750 of a corresponding bundle may be valid.
Option 2: All the TOs 700, 710, and 720, or 730, 740, and 750 of the bundle may be invalid.
Option 3: The TOs 700, 710, and 750 belonging to an AP among the TOs of the bundle may be valid, and the TOs 720, 730, and 740 belonging to an NAP may be invalid.
Option 4: Based on the first TO among the TOs of the bundle,
Option 4-1: If the first TO belongs to an AP, all the TOs 700, 710, and 720 of the bundle may be valid. On the contrary, if the first TO belongs to an NAP, all the TOs 730, 740, and 750 of the bundle may be invalid.
Option 4-2: If the first TO belongs to an AP, all the TOs 700, 710, and 720 of the bundle may be valid. On the contrary, if the first TO belongs to an NAP, only the TO 750 belonging to an AP among the TOs of the bundle may be valid and the TOs 730 and 740 belonging to the NAP may be invalid.
Option 4-3: If the first TO belongs to an AP, only the TOs 700 and 710 belonging to the AP among the TOs of the bundle may be valid and the TO 720 belonging to an NAP may be invalid. On the contrary, if the first TO belongs to an NAP, all the TOs 730, 740, and 750 of the bundle may be invalid.
Option 4-4: If the first TO belongs to an AP, only the TOs 700 and 710 belonging to the AP among the TOs of the bundle may be valid and the TO 720 belonging to an NAP may be invalid. On the contrary, if the first TO belongs to an NAP, only the TO 750 belonging to an AP among the TOs of the bundle may be valid and the TOs 730 and 740 belonging to the NAP may be invalid.
Option 5: If the base station configures a particular function, whether the TO is valid may be determined as one of option 1 to option 4 above. If the function is not configured, whether the TO is valid may be determined as one of option 1 to option 4 above. The function may be configured in a unit of a UE, a unit of a cell, a unit of a bandwidth part (BWP), or a unit of a CG/SPS.

As an embodiment of the disclosure, if some of the TOs belonging to a particular bundle are valid and the other TOs are invalid, the RV value of a particular valid TO may be determined based on which ordinal number the TO is among all the TOs belonging to the bundle. For example, if the bundle is a PDSCH bundle, when the TO is an n-th TO (n starts from 0), the RV of the TO may be configured to be a value corresponding to n mod 4 among the values defined in [Table 2] below.

TABLE 2

| n mod 4 = 0 | n mod 4 = 1 | n mod 4 = 2 | n mod 4 = 3 |
|---|---|---|---|
| 0 | 2 | 3 | 1 |

As an embodiment of the disclosure, if some of the TOs belonging to a particular bundle are valid and the other TOs are invalid, the RV value of a particular valid TO may be determined based on which ordinal number the valid TO is among all the valid TOs belonging to the bundle. For example, if the bundle is a PUSCH bundle, when the TO is an n-th active TO (n starts from 1) among all the active TOS, the RV value of the TO may be configured to be a k-th value of repK-RV. n and k may have a correlation based on a previously defined rule. For example, n and k may have a relation of k=(mod(n−1,4)+1). For example, if the bundle is a PDSCH bundle, when the TO is an n-th active TO (n starts from 0) among all the active TOs, the RV of the TO may be configured to be a value corresponding to n mod 4 among the values defined in [Table 3] below.

TABLE 3

| n mod 4 = 0 | n mod 4 = 1 | n mod 4 = 2 | n mod 4 = 3 |
|---|---|---|---|
| 0 | 2 | 3 | 1 |

As an embodiment of the disclosure, in a CG having startingFromRV0 configured to be On through an RRC message, initial transmission of a TB transmitted through a PUSCH bundle allocated by the CG may be possible only in a TO corresponding to RV 0 in the bundle. For example, in a CG having startingFromRV0 configured to be off through an RRC message, initial transmission of a TB transmitted through a PUSCH bundle allocated by the CG may be possible only in the first TO in the bundle.

As an embodiment of the disclosure, in a CG having startingFromRV0 configured to be On through an RRC message, if some of the TOs belonging to a particular PUSCH bundle are valid and the other TOs are invalid, initial transmission of a TB transmitted through the PUSCH bundle may be possible only in a valid TO corresponding to RV 0 in the bundle. For example, in a CG having startingFromRV0 configured to be Off through an RRC message, if some of the TOs belonging to a particular PUSCH bundle are valid and the other TOs are invalid, initial transmission of a TB transmitted through the PUSCH bundle may be possible only in the first valid TO in the bundle.

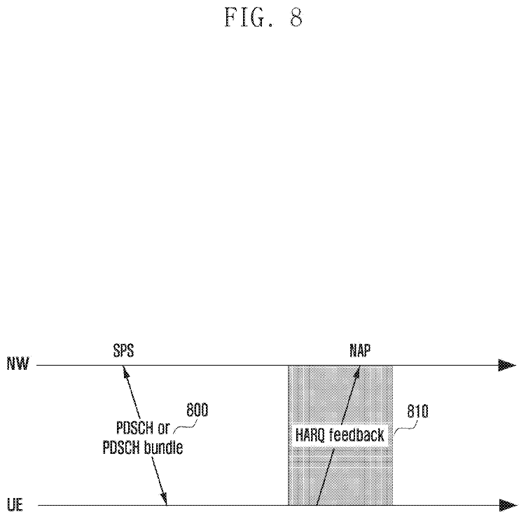

FIG. 8 is a diagram illustrating a criterion for determining whether a particular PDSCH or PDSCH bundle allocated by SPS is valid/invalid according to an embodiment of the disclosure.

Referring to FIG. 8, for example, when the base station determines that all or some TOs 800 of a PDSCH bundle or a PDSCH allocated through SPS are valid, based on the above criterion, if all or some symbols of the transmission resource of a corresponding HARQ feedback 810 overlap an NAP, the PDSCH or all the TOs 800 of the PDSCH bundle may be invalid. For example, if the base station configures a particular function, the UE may operate according to the above operation. The function may be configured in a unit of a UE, a unit of a cell, a unit of a bandwidth part (BWP), or a unit of a CG/SPS.

For example, when the base station determines that all or some TOs 800 of a PDSCH bundle or a PDSCH allocated through SPS are valid, based on the above criterion, even if all or some symbols of the transmission resource of a corresponding HARQ feedback 810 overlap an NAP, the PDSCH or all or some TOs of the PDSCH bundle may be valid, and the HARQ feedback 810 may also be normally transmitted and received. For example, if the base station configures a particular function, the UE may operate according to the above operation. The function may be configured in a unit of a UE, a unit of a cell, a unit of a bandwidth part (BWP), or a unit of a CG/SPS.

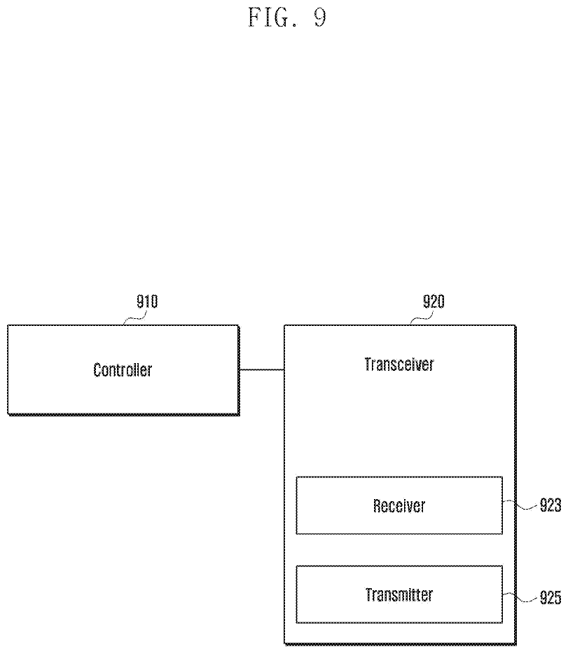

FIG. 9 illustrates a structure of a UE according to an embodiment of the disclosure.

Referring to FIG. 9, the UE according to an embodiment of the disclosure may include a transceiver 920 and a controller 910 that controls the overall operation of the UE. Also, the transceiver 920 may include a transmitter 925 and a receiver 923.

The transceiver 920 may transmit/receive signals with other network entities.

The controller 910 may control the UE to perform the operations according to any one of the above-described embodiments. The controller 910 and the transceiver 920 are not necessarily implemented as separate modules, but may be implemented as a single component unit such as a single chip. Also, the controller 910 and the transceiver 920 may be electrically connected to each other. In addition, the controller 910 may be, for example, a circuit, an application-specific circuit, or at least one processor. Moreover, the operations of the UE may be implemented by providing any unit in the UE with a memory device storing corresponding program codes.

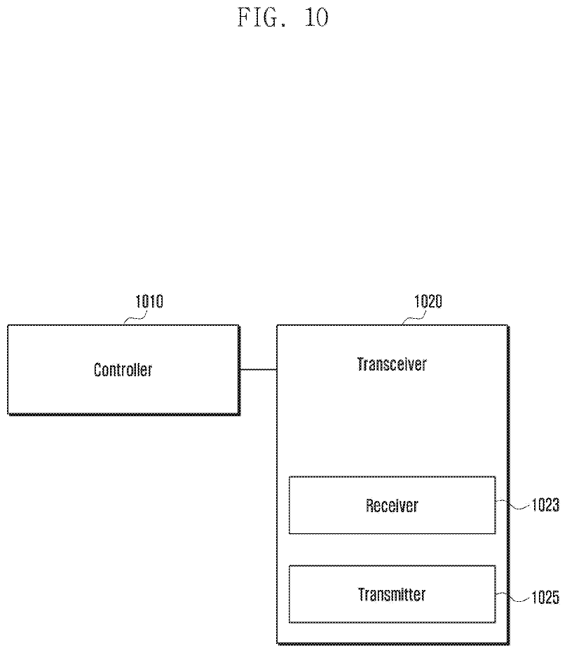

FIG. 10 illustrates a structure of a network entity according to an embodiment of the disclosure.

The network entity of the disclosure is a concept that covers network functions according to system implementations.

Referring to FIG. 10, the network entity according to an embodiment of the disclosure may include a transceiver 1020 and a controller 1010 that controls the overall operation of the network entity. Also, the transceiver 1020 may include a transmitter 1025 and a receiver 1023.

The transceiver 1020 may transmit/receive signals with other network entities.

The controller 1010 may control the network entity to perform the operations according to any one of the above-described embodiments. The controller 1010 and the transceiver 1020 are not necessarily implemented as separate modules, but may be implemented as a single component unit such as a single chip. Also, the controller 1010 and the transceiver 1020 may be electrically connected to each other. In addition, the controller 1010 may be, for example, a circuit, an application-specific circuit, or at least one processor. Moreover, the operations of the network entity may be implemented by providing any unit in the network entity with a memory device storing corresponding program codes.

The network entity may be any one of a base station, an AMF, and an SMF.

It should be noted that the configuration diagrams, illustrative diagrams of control/data signal transmission methods, illustrative diagrams of operation procedures, and structural diagrams as illustrated in FIG. 1 to FIG. 10 are not intended to limit the scope of protection of the disclosure. That is, all the constituent units, entities, or operation steps shown in FIG. 1 to FIG. 10 should not be construed as essential elements for implementing the disclosure, and even when including only some of the elements, the disclosure may be implemented without impairing the true nature of the disclosure.

The above-described operations of a base station or a terminal may be implemented by providing a memory device storing corresponding program codes in a bast station or terminal device. That is, a controller of the base station or terminal device may perform the above-described operations by reading and executing the program codes stored in the memory device by means of a processor or central processing unit (CPU).

Various units and modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. A method performed by a terminal in a wireless communication system, the method comprising:
receiving, from a base station, at least one of semi persistent scheduling (SPS) configuration information related to repetition of a data transmission according to an SPS, or configured grant configuration information related to repetition of a data transmission according to a configured grant; and
receiving, from the base station, configuration information on at least one of a cell discontinuous transmission (DTX) or a cell discontinuous reception (DRX),
wherein, in case that the cell DTX is configured for a serving cell and the serving cell is not in a cell DTX active period, downlink data is not received according to a configured downlink assignment for the SPS, and
wherein, in case that the cell DRX is configured for the serving cell and the serving cell is not in a cell DRX active period, an uplink data transmission is not triggered according to the configured grant.

17. The method of claim 16, wherein the at least one of the SPS configuration information or the configured grant configuration information is included in a radio resource control (RRC) message.

18. The method of claim 16, further comprising:
in case that the cell DTX is configured for the serving cell and the serving cell is in the cell DTX active period, receiving, from the base station, downlink data according to the configured downlink assignment for the SPS; and
in case that the cell DRX is configured for the serving cell and the serving cell is in the cell DRX active period, triggering an uplink data transmission according to the configured grant.

19. The method of claim 16, wherein the cell DTX active period is determined based on timer information included in the configuration information on the cell DTX, and
wherein the cell DRX active period is determined based on timer information included in the configuration information on the cell DRX.

20. A method performed by a base station in a wireless communication system, the method comprising:
transmitting, to a terminal, at least one of semi persistent scheduling (SPS) configuration information related to repetition of a data transmission according to an SPS, or configured grant configuration information related to repetition of a data transmission according to a configured grant; and
transmitting, to the terminal, configuration information on at least one of a cell discontinuous transmission (DTX) or a cell discontinuous reception (DRX),
wherein, in case that the cell DTX is configured for a serving cell and the serving cell is not in a cell DTX active period, downlink data is not transmitted according to a configured downlink assignment for the SPS, and
wherein, in case that the cell DRX is configured for the serving cell and the serving cell is not in a cell DRX active period, uplink data is not received according to the configured grant.

21. The method of claim 20, wherein the at least one of the SPS configuration information or the configured grant configuration information is included in a radio resource control (RRC) message.

22. The method of claim 20, further comprising:
in case that the cell DTX is configured for the serving cell and the serving cell is in the cell DTX active period, transmitting, to the terminal, downlink data according to the configured downlink assignment for the SPS; and
in case that the cell DRX is configured for the serving cell and the serving cell is in the cell DRX active period, receiving, from the terminal, uplink data according to the configured grant.

23. The method of claim 20, wherein the cell DTX active period is determined based on timer information included in the configuration information on the cell DTX, and
wherein the cell DRX active period is determined based on timer information included in the configuration information on the cell DRX.

24. A terminal of a wireless communication system, the terminal comprising:
a transceiver; and
a controller coupled with the transceiver and configured to:
receive, from a base station, at least one of semi persistent scheduling (SPS) configuration information related to repetition of a data transmission according to an SPS, or configured grant configuration information related to repetition of a data transmission according to a configured grant, and
receive, from the base station, configuration information on at least one of a cell discontinuous transmission (DTX) or a cell discontinuous reception (DRX),
wherein, in case that the cell DTX is configured for a serving cell and the serving cell is not in a cell DTX active period, downlink data is not received according to a configured downlink assignment for the SPS, and
wherein, in case that the cell DRX is configured for the serving cell and the serving cell is not in a cell DRX active period, an uplink data transmission is not triggered according to the configured grant.

25. The terminal of claim 24, wherein the at least one of the SPS configuration information or the configured grant configuration information is included in a radio resource control (RRC) message.

26. The terminal of claim 24, wherein the controller is further configured to:
in case that the cell DTX is configured for the serving cell and the serving cell is in the cell DTX active period, receive, from the base station, downlink data according to the configured downlink assignment for the SPS, and
in case that the cell DRX is configured for the serving cell and the serving cell is in the cell DRX active period, trigger an uplink data transmission according to the configured grant.

27. The terminal of claim 24, wherein the cell DTX active period is determined based on timer information included in the configuration information on the cell DTX, and
wherein the cell DRX active period is determined based on timer information included in the configuration information on the cell DRX.

28. A base station of a wireless communication system, the base station comprising:
a transceiver; and
a controller coupled with the transceiver and configured to:
transmit, to a terminal, at least one of semi persistent scheduling (SPS) configuration information related to repetition of a data transmission according to an SPS, or configured grant configuration information related to repetition of a data transmission according to a configured grant, and
transmit, to the terminal, configuration information on at least one of a cell discontinuous transmission (DTX) or a cell discontinuous reception (DRX),
wherein, in case that the cell DTX is configured for a serving cell and the serving cell is not in a cell DTX active period, downlink data is not transmitted according to a configured downlink assignment for the SPS, and
wherein, in case that the cell DRX is configured for the serving cell and the serving cell is not in a cell DRX active period, uplink data is not received according to the configured grant.

29. The base station of claim 28, wherein the at least one of the SPS configuration information or the configured grant configuration information is included in a radio resource control (RRC) message.

30. The base station of claim 28, wherein the controller is further configured to:
in case that the cell DTX is configured for the serving cell and the serving cell is in the cell DTX active period, transmit, to the terminal, downlink data according to the configured downlink assignment for the SPS, and
in case that the cell DRX is configured for the serving cell and the serving cell is in the cell DRX active period, receive, from the terminal, uplink data according to the configured grant.

31. The base station of claim 28, wherein the cell DTX active period is determined based on timer information included in the configuration information on the cell DTX, and
wherein the cell DRX active period is determined based on timer information included in the configuration information on the cell DRX.
